(19) United States
(12) Patent Application Publication
(10) Pub. No.: US 2010/0044538 A1
(43) Pub. Date: Feb. 25, 2010

(54) ASSEMBLY DEVICE FOR DISPLAY SCREEN

(75) Inventor: CHIA-EN LEE, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/495,869

(22) Filed: Jul. 1, 2009

(30) Foreign Application Priority Data
Aug. 19, 2008 (CN) 200810304033.X

(51) Int. Cl. F16B 47/00

(52) U.S. Cl. 248/205.8

(57) ABSTRACT

An assembly device for display screen includes a vacuum source generating vacuum, a connecting tube connecting with the vacuum source, a holding body connecting with the connecting, and a suction member connecting the holding body. The holding body includes a main portion and a connecting portion laterally extending form the main portion, the vacuum source, the connecting tube, the holding body, and the suction member communicates with each other in order and forms a passage for gas, the display screen can be gripped by the suction cover by action of the vacuum source.

### BACKGROUND

1. Technical Field

The present disclosure relates to assembly devices, particularly to a device for assembling a display screen to an electronic device.

2. Description of Related Art

Portable electronic devices such as mobile phones generally have display panels with display screens affixed. Typically, a display screen is manually adhered to an electronic device and it is difficult for a worker to accurately position the display screen on the display panel and also easy for the display screen to be contaminated

Therefore, there is chamber for improvement within the art.

### BRIEF DESCRIPTION OF THE DRAWING

Many aspects of the present assembly device for display screen can be better understood with reference to the following drawings. The components in the various drawings are not necessarily drawn to scale, the emphasis instead being placed upon clearly illustrating the principles of the present assembly device for display screen. Moreover, in the drawings, like reference numerals designate corresponding parts throughout the diagrams.

FIG. 1 is a disassembled view of an exemplary display screen assembly device.

FIG. 2 is an assembled, isometric view of the assembly device shown in FIG. 1.

FIG. 3 is an assembled, cut-away view of the assembly device shown in FIG. 1.

FIG. 4 is similar to FIG. 3 but with the assembly device in use.

### DETAILED DESCRIPTION

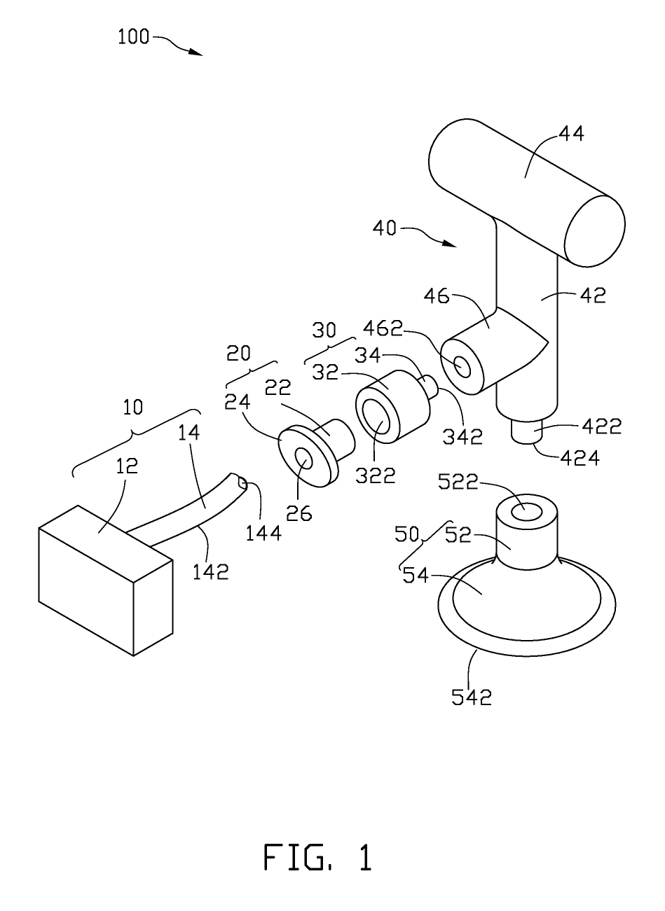

Referring to FIG. 1, an assembly device 100 can be used for assembling display screens to housings of mobile phones and other portable electronic devices, such as personal digital assistants (PDAs), digital cameras, and others. The assembly device 100 includes a vacuum source 10, a connecting cap 20, a connecting tube 30, a holding body 40, and a suction member 50.

The vacuum source 10 includes a vacuum generator 12 and a connecting pipe 14 connected to the vacuum generator 12. The connecting pipe 14 has a circumferential pipe wall 142 and a pipe passage 144 surrounded by the pipe wall 142.

The connecting cap 20 is for securing the connecting pipe 14 to the connecting tube 30 includes a tube body 22 and a flange 24 at an end of the tube body 22. The tube body 22 defines a through receiving hole 26 having substantially the same size as the connecting pipe 14 so as to engagably receive the connecting pipe 14 therein.

The connecting tube 30 include a first sleeve portion 32 and a second sleeve portion 34 protruding from an end of the first sleeve portion 32. The first sleeve portion 32 defines a central circular first cavity 322 extending along an axis thereof for engagably receiving the tube body 22. The second sleeve portion 34 defines a central circular second cavity 342 communicating with the first cavity 322.

The holding body 40 includes a main portion 42, a handle 44, and a connecting portion 46. The main portion 42 is cylindrical and has an engaging portion 422 axially extending from an end thereof. The engaging portion 422 is configured for connecting with the suction member 50. The handle 44, which is cylindrical, perpendicularly connects with the top of the main portion 42. The connecting portion 46, which is cylindrical, extends laterally from the sidewall of the main portion 42. The connecting portion 46 defines a central circular first recess 462 in the end wall thereof. The first recess 462 axially extends to the main portion 42. The engaging portion 422 defines a central circular second recess 424 in the end wall thereof. The second recess 424 axially extends to communicate with the first recess 462 of the connecting portion 46. The first recess 462 and the second recess 424 are substantially crossed.

The suction member 50 is made of rubber or other elastic material and includes an engaging end portion 52 and a suction cover 54 at an end of the engaging end portion 52. The engaging end portion 52 defines a connecting aperture 522 extending along the axis of the engaging end portion 52. The suction cover 54 is generally tapered for forming a seal on a display screen and allowing creation of suction and encloses a receiving chamber 542 communicating the connecting aperture 522.

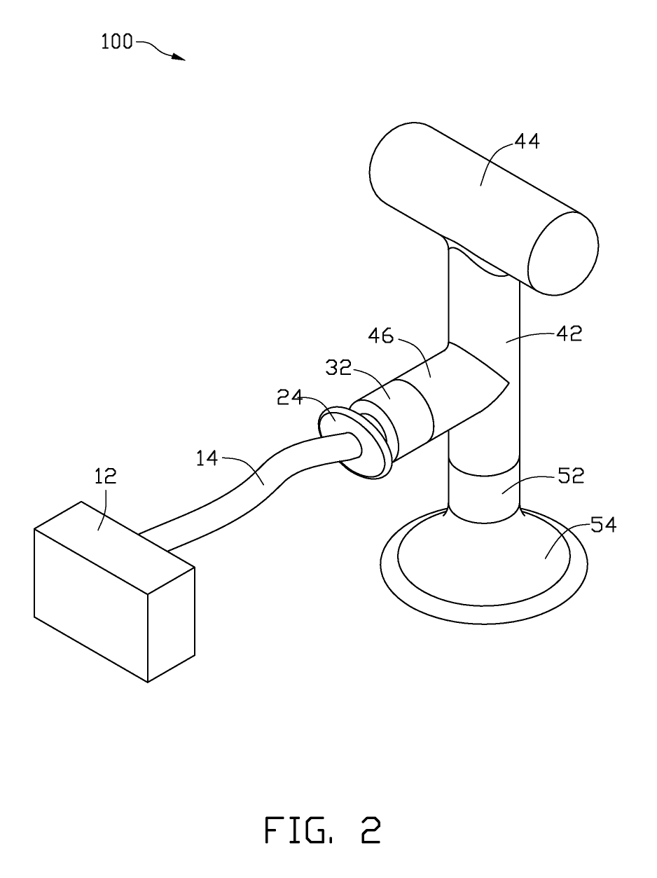

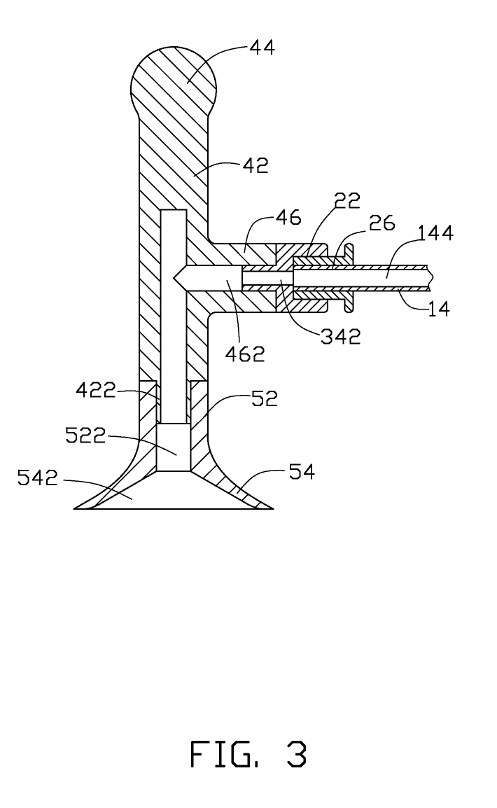

Referring FIGS. 2 and 3, to assemble the assembly device 100, the connecting pipe 14 is inserted into the receiving hole 26 of the connecting cap 20. The tube body 22 of the connecting cap 20 is securely received in the first cavity 322 of the connecting tube 30. At this time, the connecting pipe 14 is aligned above the second cavity 342 of the second sleeve portion 34. The second sleeve portion 34 is inserted into the first recess 462 of the connecting portion 46. The second cavity 342 communicates with the first recess 462. The engaging portion 422 of the holding body 40 is secured in the connecting aperture 522 and thus the second recess 424 of the engaging portion 422 communicates with the connecting aperture 522. After assembly, the pipe passage 144 of the connecting pipe 14, the second cavity 342 of the second sleeve portion 34, the first recess 462 of the connecting portion 46, the second recess 424 of the engaging portion 422, the connecting aperture 522 of the engaging end portion 52, and the receiving chamber 542 of the suction cover 54 communicate with each other in the written order and form a passage for gas.

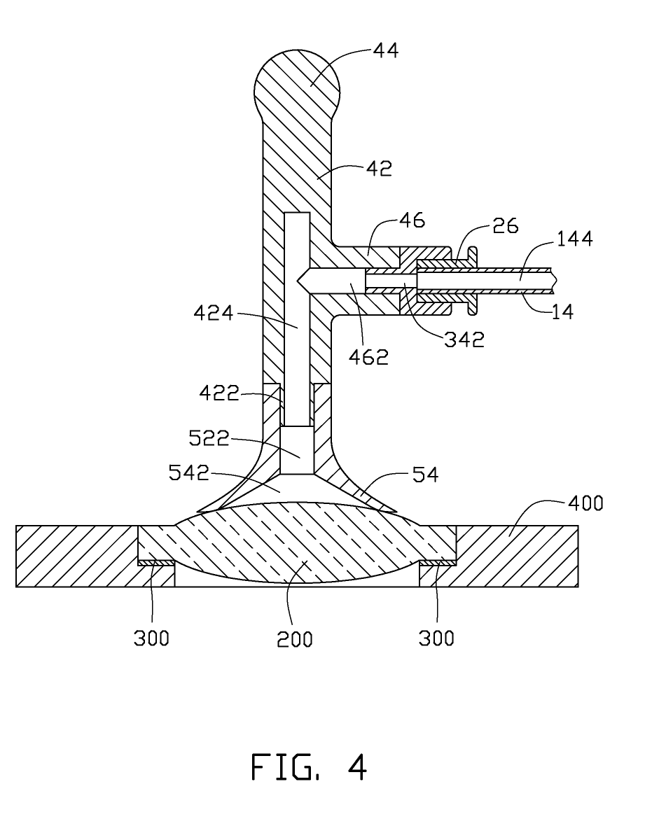

Referring FIG. 4, to implement the assembly device to assemble the display screen 200 to a housing 400 of an electronic device, the surface of the display screen 200 is partially tightly pressed by the suction cover 54. The vacuum source 10 and the vacuum generator 12 works to create a vacuum in the receiving chamber 542 to suck the display screen 200 to the suction cover 44. The handle 44 then can be grasped and the holding body 40 together with the display screen 200 can be moved about. Thus, the display screen 200 can be easily and accurately maneuvered to be adhered to the housing 200 for example, by an adhesive glue 300.

It is to be understood that the connecting cap 20 and the connecting tube 30 can be omitted, accordingly, the vacuum source 10 is directly connected to the connecting portion 46 of the holding body 40.

It is to be understood that even though numerous characteristics and advantages of the present embodiments have been set forth in the foregoing description, together with details of assemblies and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An assembly device for display screen, comprising:
a vacuum source generating vacuum;
a holding body including a main portion and a connecting portion laterally extending form the main portion; and
a suction member having a suction cover;
wherein the connecting portion defines a first recess, the main portion defines a second recess communicating with the first recess, the vacuum source communicates with the first recess, the suction member is received in the second recess, the vacuum source, the first recess, the second recess, and the suction cover communicates with each other in order and form a passage for suction, so a display screen can be gripped by the suction cover and moved about.

2. The assembly device for display screen as claimed in claim 1, wherein the assembly device future includes a connecting tube, the connecting tube connects the vacuum source and the connecting portion of the holding body respectively.

3. The assembly device for display screen as claimed in claim 2, wherein the connecting tube includes a first sleeve portion and a second sleeve portion protruding from an end of the first sleeve portion, the first sleeve portion is used to connect the vacuum source, the second sleeve portion is received in the first recess of the connecting portion compactly.

4. The assembly device for display screen as claimed in claim 3, wherein the assembly device future includes a connecting cap, the vacuum source includes a connecting pipe, the first sleeve portion defines a first cavity therein, the connecting cap is configured for securing the connecting pipe into the first cavity of the connecting tube.

5. The assembly device for display screen as claimed in claim 3, wherein the second sleeve portion defines a second cavity communicating with the first cavity, the connecting pipe is received in the first cavity and communicates with the second cavity.

6. The assembly device for display screen as claimed in claim 1, wherein the holding body includes a handle perpendicularly connecting with the main portion, the handle is used for user holding.

7. The assembly device for display screen as claimed in claim 1, wherein the main portion has an engaging portion protruding from an end of the main portion, the suction member includes an engaging end portion defining a connecting aperture, the engaging portion defining the said second recess is received in the connecting aperture.

8. The assembly device for display screen as claimed in claim 7, wherein suction member includes a suction cover integrally connecting the engaging end portion, the suction cover encloses a receiving chamber interconnecting with the connecting aperture.

9. An assembly device for display screen, comprising:
a vacuum source generating vacuum;
a connecting tube connecting with the vacuum source;
a holding body connecting with the connecting, and
a suction member connecting the holding body;
wherein the holding body includes a main portion and a connecting portion laterally extending form the main portion, the vacuum source, the connecting tube, the holding body, and the suction member forms a passage for suction, the display screen can be gripped by the suction cover by action of vacuum source.

10. The assembly device for display screen as claimed in claim 9, wherein the holding body includes a connecting portion defining a first recess, and a main portion defining a second recess communicating with the first recess.

11. The assembly device for display screen as claimed in claim 10, wherein the connecting tube includes a first sleeve portion and a second sleeve portion protruding from an end of the first sleeve portion, the first sleeve portion is used to connect the vacuum source, the second sleeve portion is received in the first recess of the connecting portion compactly.

12. The assembly device for display screen as claimed in claim 11, wherein the assembly device future includes a connecting cap, the vacuum source includes a connecting pipe, the first sleeve portion defines a first cavity therein, the connecting cap is configured for securing the connecting pipe into the first cavity of the connecting tube.

13. The assembly device for display screen as claimed in claim 9, wherein the main portion has an engaging portion protruding from an end of the main portion, the suction member includes an engaging end portion defining a connecting aperture, the engaging portion is received in the connecting aperture.
